(19) United States
(12) Patent Application Publication
(10) Pub. No.: US 2026/0228064 A1
(43) Pub. Date: Aug. 6, 2026

(54) EVENT-BASED INTROSPECTION PROTOCOL FOR LANDSCAPE AND EVENT EXCHANGE MONITORING

(71) Applicant: SAP SE, Walldorf (DE)

(72) Inventors: Tatjana Pfeifer, Altrip (DE); Jens-Christoph Nolte, Sandhausen (DE)

(21) Appl. No.: 19/532,245

(22) Filed: Feb. 6, 2026

Related U.S. Application Data
(60) Provisional application No. 63/754,637, filed on Feb. 6, 2025.

(51) Int. Cl. G06F 9/54

(52) U.S. Cl. CPC G06F 9/546; G06F 9/542

(57) ABSTRACT

In an event-based introspection protocol for landscape and event exchange monitoring, an event client subscribes as an event client with a messaging infrastructure. The event client publishes a client connected message to the messaging infrastructure. The event client publishes a client alive ping message to the messaging infrastructure. The event client consumes event data from one or more other event clients subscribed to the messaging infrastructure from the messaging infrastructure. The event client processes status information based on the consumed event data from one or more other event clients. The event client adds the processed status information to a status table. The event client sends a client disconnected message to the messaging infrastructure to disconnect from the messaging infrastructure.

### CROSS-REFERENCE TO RELATED APPLICATIONS

This application is a continuation of U.S. Provisional Patent Application No. 63/754,637, filed on Feb. 6, 2025, which is incorporated by reference in its entirety.

### BACKGROUND

Currently, event-driven communication patterns are used to connect software applications (e.g., business or other software applications) in a loosely coupled manner, allowing software applications to communicate with each other without knowing or having direct connections (i.e., point-to-point) with each other. Events are used to support the loosely coupled communication, as they are used to transport relevant information from one application to another using a messaging infrastructure. Any software application can connect to the messaging infrastructure to either publish information using events or to subscribe to events it considers relevant. But a software application is not concerned about ultimate recipients of the events or of the original producers of the events.

### SUMMARY

The present disclosure describes event-based introspection protocol for landscape and event exchange monitoring.

In an implementation, a computer-implemented method for event-based introspection protocol for landscape and event exchange monitoring, comprises: subscribing, by an event client and with a messaging infrastructure, as an event client; publishing, by the event client and to the messaging infrastructure, a client connected message; publishing, by the event client, and to the messaging infrastructure, a client alive ping message; consuming, by the event client and from the messaging infrastructure, event data from one or more other event clients subscribed to the messaging infrastructure; processing, by the event client and based on the consumed event data from one or more other event clients, status information; adding, by the event client and to a status table, the processed status information; and sending, by the event client and to the messaging infrastructure, a client disconnected message to disconnect from the messaging infrastructure.

The described subject matter can be implemented using a computer-implemented method; a non-transitory, computer-readable medium storing computer-readable instructions to perform the computer-implemented method; and/or a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIGS. 1A & 1B represent a block diagram illustrating an example of an infrastructure for an event-based introspection protocol for landscape and event exchange monitoring, according to an implementation of the present disclosure.

FIG. 2 represents a swim diagram illustrating an example of usage of an event-based introspection protocol for landscape and event exchange monitoring, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

FIG. 4 is a flowchart illustrating an example of a computer-implemented method for event-based introspection protocol for landscape and event exchange monitoring, according to an implementation of the present disclosure.

Like reference numbers and designations in the various drawings indicate like elements.

### DETAILED DESCRIPTION

The following detailed description describes event-based introspection protocol for landscape and event exchange monitoring and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as not to obscure one or more described implementations. The present disclosure is not intended to be limited to the described or illustrated implementations, but to be accorded the widest scope consistent with the described principles and features.

Currently, event-driven communication patterns are used to connect software applications (e.g., business or other software applications) in a loosely coupled manner, allowing software applications to communicate with each other without knowing or having direct connections (i.e., point-to-point) with each other. Events are used to support the loosely coupled communication, as they are used to transport relevant information from one application to another using a messaging infrastructure. Any software application can connect to the messaging infrastructure to either publish information using events or to subscribe to events it considers relevant. But a software application is not concerned about ultimate recipients of the events or of the original producers of the events.

To set up and to maintain software applications for event consumption and publishing is straightforward, as there are enough specifications and libraries for different protocols available (e.g., Hypertext Transfer Protocol (HTTP)). However, a difficult task is to monitor event traffic (e.g., to trace if events have eventually been delivered in a certain integration scenario) and status of availability of software applications acting as event clients. Only if the availability of the software application is clarified can events be exchanged reliably.

Described is an approach whereby software applications acting as event clients for a dedicated messaging infrastructure instance may implement a decentralized monitoring protocol which allows each client to broadcast its role in an integration scenario. Additionally, it can also be used to publish changes about its lifecycle to the other participants going forward.

Other event clients can subscribe to lifecycle events. With the subscription, the other even clients can react to and/or collect events, analyze status information about other event clients, and verify delivery/reception of events (to or by other applications participating in the respective integration scenario) has been completed successfully and all events have reached their destination.

In some implementations, a topic-based subscription can be used to remove a need for persistent queues in the messaging infrastructure to understand the monitoring protocol and to maintain subscriptions for the corresponding monitoring messages in the respective queues. Thereby, additional configuration effort is saved and yet, integration is always available when needed.

In some implementations, the protocol defines different message types. For example, the following three message types can be defined, which can be used to express a certain phase in a lifecycle of a client and statistics with regards to event delivery/consumption:

### Client Connected

1. CLIENT_CONNECTED: indicates that:
   a. an event client has been connected to the messaging infrastructure instance. The event client can configure one or many connections (referred to as ‘Channel’ in the examples below). The CLIENT_CONNECTED event must be sent per connection configurated for the current eventing client.
   b. and other clients can expect to regularly receive messages of type CLIENT_ALIVE_PING from this client/connection until the client gets disconnected
   c. if the CLIENT_ALIVE_PING event is not received at the frequency that has been stated by the CLIENT_CONNECTED event of the connected client it might be indication for a connection problem and must be checked
   d. and that the event client is subscribed to lifecycle events from other event clients
   e. a variety of additional fields may be included by the customer in the message to indicate different aspects of the event client (e.g., event configuration about published/subscribed event types, etc.) depending on their needs.

### Example Message

```
CLIENT_CONNECTED
{
  “type”: “namespace.EventClient.Connected.v1”,
  “specversion”: “1.0”,
  “source”: “/region/application/...”,
  “id”: “xxxxx”,
  “time”: “2020-08-14T06:21:52Z”,
  “datacontenttype”: “application/json”,
  “data”: {
      “ChannelID”:“New_Channel_for_BusinessPartnerEvents”
```

| | |
|---|---|
| “ConnectionType”:“AMQP” | *MQTT, WebHook, etc |
| “PingFrequency”:“10” | *in mins |

}
}.

### Client Alive Ping

2. CLIENT_ALIVE_PING:
   a. Can be published at a configurable time interval, e.g., every 10 mins, 1 h.
   b. indicates that the client sending this message is up and the connection to the messaging infrastructure is open
   c. absence of this message after a certain period indicates that the event client is not able to send the message due to some error state (connection broken, client is down, etc.)
   d. a variety of additional fields may be included by the customer depending on their needs in the message to indicate different aspects of the event client
      i. configuration changes since last PING message
      ii. event statistics
         1. count of events published per event type
         2. count of events consumed per event type
         3. count of events failed to be published per event type
         4. count of events failed to be consumed per event type
      iii. for the event statistics a timestamp of the last message publishing/reception between the last and the current PING event.

### Example Message

```
CLIENT_ALIVE_PING
{
  “type”: “namespace.EventClient.Alive_Ping.v1”,
  “specversion”: “1.0”,
  “source”: “/region/application/...”,
  “id”: “xxxxx”,
  “time”: “2020-08-14T06:21:52Z”,
  “datacontenttype”: “application/json”,
  “data”: {
      “ChannelID”:“New_Channel_for_BusinessEvents”
    “ChannelStatus”:“OK”
    “ChannelLoad”:“100” *Events or MB
    “Events published”:{
      “ namespace.SalesOrderCreated.v1”:{
          “Count”:“10”
          “Last_timestamp”:“2020-08-14T06:21:40Z” *Timestamp of
        the publishing of the last event in the timeframe between the last and
        the current PING Event.
          }
      “ namespace.BusinessPartnerCreated.v1”:{
          “Count”:“150”
          “Last_timestamp”:“2020-08-14T06:21:52Z”
          }
    }
    “Events consumed”:{
      “ namespace.SalesOrderDeleted.v1”:{
          “Count”:“50”
          “Last_timestamp”:“2020-08-14T06:21:30Z”*Timestamp of
        the consumption of the last event in the timeframe between the last
        and the current PING Event.
          }
      “ namespace.BusinessPartnerChanged.v1”:{
          “Count”:“10”
          “Last_timestamp”:“2020-08-14T06:21:50Z”
          }
    }
  }
}.
```

### Client Disconnected

3. CLIENT_DISCONNECTED
   a. Indicates that the connection to the messaging infrastructure was closed/deactivated actively by the software application in which the event client runs.
   b. No further messages of type CLIENT_ALIVE_PING are expected from this event client.
   c. a variety of additional fields may be included by the customer in the message to indicate different aspects of the event client (e.g., reasons for disconnect, error messages, final event delivery/consumption statistics, etc) depending on their needs
   d. event statistics
      i. count of events published per event type
      ii. count of events consumed per event type
      iii. count of events failed to be published per event type
      iv. count of events failed to be consumed per event type
   e. for the event statistics a timestamp of the last message publishing/reception between the last PING and the CLIENT_DISCONNECTED event.

### Example Message

```
CLIENT_DISCONNECTED:
{
  “type”: “namespace.EventClient.Disconnected.v1”,
  “specversion”: “1.0”,
  “source”: “/region/application/...”,
  “id”: “xxxxx”,
  “time”: “2020-08-14T06:23:52Z”,
  “datacontenttype”: “application/json”,
  “data”: {
    “ChannelID”:“New_Channel_for_BusinessEvents”
      “Reason”:“channel_deactivated” *channel_deleted, etc
    “Events published”:{
      “ namespace.SalesOrderCreated.v1”:{
          “Count”:“20”
          “Last_timestamp”:“2020-08-14T06:23:40Z” *Timestamp of
        the publishing of the last event in the timeframe between the last
        PING and the current Event.
          }
    }
    “Events consumed”:{
      “namespace.SalesOrderDeleted.v1”:{
          “Count”:“150”
          “Last_timestamp”:“2020-08-14T06:23:30Z”*Timestamp of
        the consumption of the last event in the timeframe between the last
        PING and the current event.
          }
    }
  }
}.
```

As will be understood by those of ordinary skill in the art, other message types consistent with this disclosure can be defined.

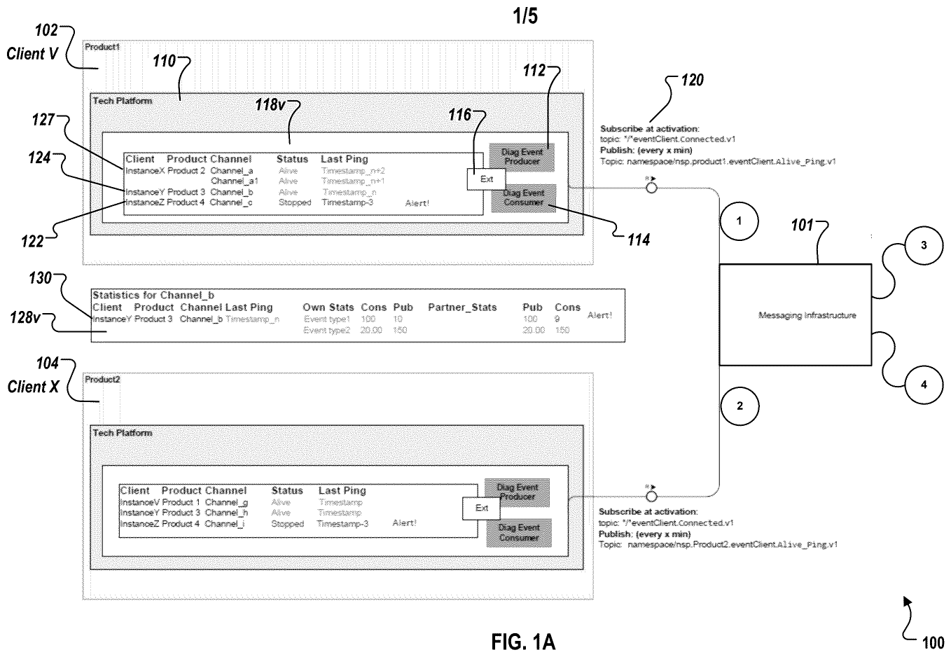

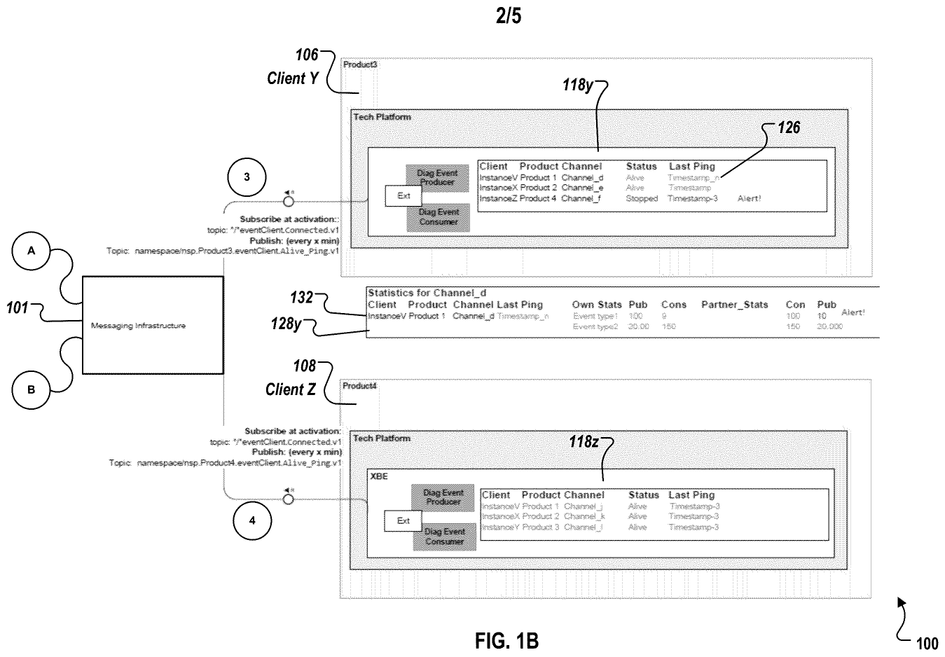

FIGS. 1A & 1B represent a block diagram 100 illustrating an example of an infrastructure for an event-based introspection protocol for landscape and event exchange monitoring, according to an implementation of the present disclosure.

In FIG. 1A, block diagram 100 illustrates a messaging infrastructure 101, product1 (client V) 102, and product2 (client X) 104. Turning to FIG. 1B, similarly, block diagram 100 illustrates the messaging infrastructure 101, product3 (client Y) 106, and product4 (client Z) 108.

Messaging infrastructure 101 is a software module(s) or application(s) that permits use of event driven applications and connection of clients. The messaging infrastructure is useful with applications that produce data (an event producer) at a rate different than the rate at which another application consumes the data (an event consumer). Additionally, the messaging infrastructure permits building integrations between communication partners without dependencies, allowing decoupling of applications and providing buffers/queues (e.g., to supply a fast producer a data storage location and a slow consumer access to stored data at the same time). As an example, an event producer can produce data (e.g., using an event producer API), and an event consumer can define (e.g., using an event consumer API) a queue for itself for the event producer's data to be retrieved according to the operation of the event consumer. In some implementations, different functionality can be provided depending on the event provider, event consumer, etc.

Returning to FIG. 1A, in order to avoid duplicative description, client V 102 will be generally described as representative of client X 104, client Y 106, and client Z 108. Client V 102 includes a technology (tech) platform 110, diagnostic (diag) event producer 112, diag event consumer 114, extension (ext) 116, and status table 118.

The tech platform 110 is a software application that provides built-in functionality supporting the event-based introspection protocol for landscape and event exchange monitoring. For example, the tech platform 110 can be underlying functionality (e.g., XBE) provided by the Advanced Business Application Programming language supplied by SAP SE of Walldorf, Germany. In some cases, the tech platform 110 can be omitted or an alternative application can be used in its place to provide necessary functionality.

The diag event producer 112 provides capabilities to generate events associated with client V 102 which are transmitted to the messaging infrastructure 101 to be made available for consumption by other clients. The diag event consumer 114 provides capabilities to receive events from other clients (e.g., monitoring events) connected to the messaging infrastructure. In some implementations, both the diag event producer 112 and diag event consumer 114 can be combined into a single component or divided into multiple components.

Ext 116 permits applications to extent event production/consumption or for other purposes. For example, detection of other eventing clients or other applications connected to the messaging infrastructure, generating statistics about produced/consumed events. Ext 116 also permits building other types of applications consistent with the disclosure.

Upon activation of client V 102, client V 102 subscribes to the messaging infrastructure 101 by sending, e.g., a message 120. In the provided example, at activation, client V 102 sends a CLIENT_CONNECTED message and a CLIENT_ALIVE_PING message (as described above). Client V 102 will now regularly receive messages of type CLIENT_ALIVE_PING through this client/connection from other clients (and they from client V 102) until client V 102 (or other client(s) is disconnected.

The status table 118v of client V 102 compiles received monitoring events into a table which reflects a current state of other event clients (e.g., client X 104, client Y 106, and client Z 108). For example, status table 118v includes an entry 122 that client Z 108 is no longer connected to the messaging infrastructure (i.e., entry 122 indicates that there is a “Stopped” status and what the last ping value was (“Timestamp-3)) Here, the other clients may have been expecting further events based on CLIENT_ALIVE_PING from client z 108, but the expected time stamp has passed with no CLIENT DISCONNECTED event received, so an assumption is made that client z 108 is stopped. Note that client X 104 and client Y 106 also indicate a similar issue with client Z 108 in their status tables.

This allows simple monitoring of integration scenarios and to inform using appropriate tools if any integration tracks are no longer available (e.g., if an application is relying on events being consumed in client Z 108 or events to be published by client Z 108). Since the applications are aware of an alert/issue with client Z 108, appropriate notifications can be made to address the issue or, for example, to possibly switch over to a failover scenario using a different client(s).

Continuing with the example, client V 102 and client Y 104 are exchanging events with each other (e.g., see entries 124 and 126 (of status tables 118v and 118y) in clients v 102 and Y 106, respectively. Note that entry 127 in status table 118v indicates two different channels (here, “Channel_a” and “Channel_a1”). The channels are connections between a product and messaging infrastructure 101. For example, one instance of a product could be connected to two different messaging infrastructures.

Statistics can be verified for each by reviewing an associated statistics table 128v and 128y for each entry in the status tables 118v and 118y, respectively, associated with client V 102 and client Y 106. In FIG. 1A, statistics table 128v has an entry 130 (see, analogously, entry 132 in status table 118z of FIG. 1B for client Y 106). For example, statistics with regard to a published/consumed event can be verified against statistics provided through the lifecycle events of the communication partner. If there was a discrepancy, this would indicate that events have not reached a targeted consumer or the configuration of a consumer does not allow receipt of certain event types. For example, entry 130 of statistics table 128v indicates that client Y 106 published 10 events of “Event type 1”, but only 9 were consumed by client X 102. Similarly, entry 132 of statistics table 128y indicates that client V 102 consumed 9 events of “Event type 1,” but client Y 106 published 10. This situation indicates an alert that needs to be addressed in some way.

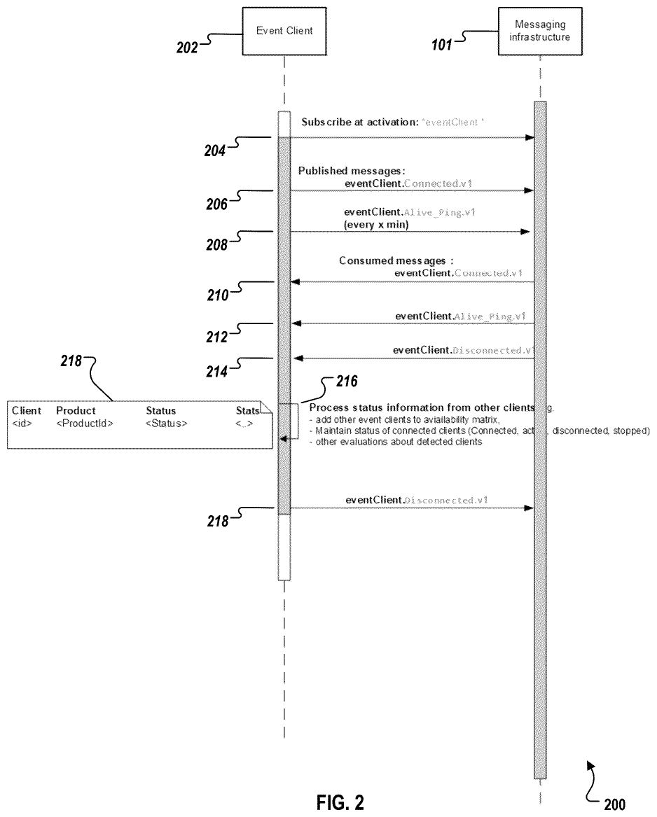

FIG. 2 represents a swim diagram 200 illustrating an example of usage of an event-based introspection protocol for landscape and event exchange monitoring, according to an implementation of the present disclosure. In FIG. 2, an event client 202 and messaging infrastructure 101 (as described in FIG. 1) is illustrated.

At 204, event client 202 subscribes to the messaging infrastructure 101 at activation as an event client. The event client also subscribes for message types to consume (e.g., connected, alive, and disconnected message types). In some implementations other message types consistent with this disclosure are also available for subscription.

At 206, event client 202 publishes a CLIENT_CONNECTED message to the messaging infrastructure 101.

At 208, event client 202 publishes a CLIENT_ALIVE_PING message to the messaging infrastructure 101.

At 210-214, event client 202 consumes messages from the messaging infrastructure 101 that one or more different clients are: 210 connected, 212 alive, and 214, disconnected.

At 216, event client 202 processes status information from the one or more other clients. During the processing, the event client 202 adds other event clients to an availability matrix (e.g., stored as status table 218 and one or more associated statistics tables (not illustrated)), maintains status of connected clients (e.g., connected, active, disconnected, stopped), and performs other evaluations about detected clients.

At 218, event client 202 sends a CLIENT DISCONNECTED message to disconnect from the messaging infrastructure 101.

The subject matter described in this specification can be implemented to realize one or more of the following advantages. First, the described approach, including the infrastructure (e.g., as shown in FIGS. 1A & 1B) and the loosely coupled concept which is used to transport events is also used to monitor themselves. That is, event clients can monitor each other and do not need to implement an integration into a central monitoring tool(s). Therefore different communication methods or different technology is no longer required. Additionally, the decentralized monitoring protocol is based on topical communication and does not require any client configuration to enable it.

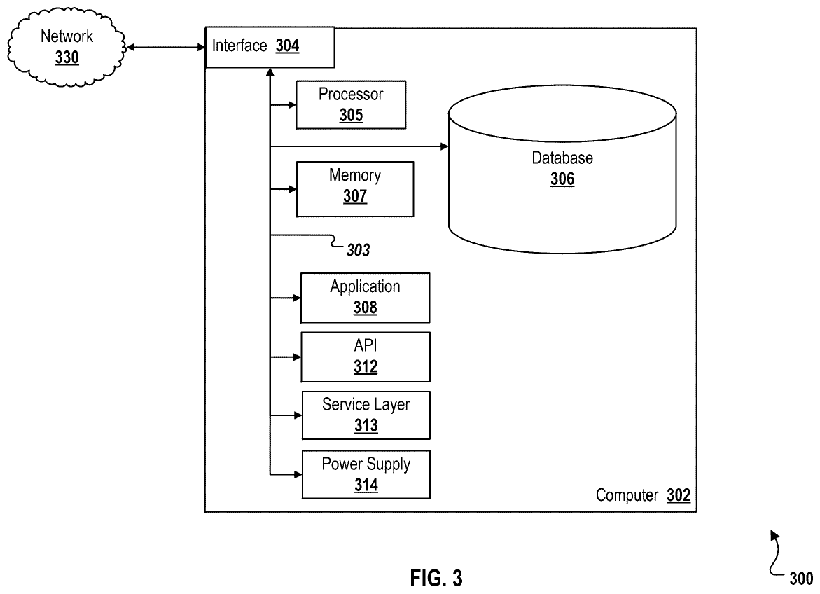

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, computer-implemented system 300 includes a Computer 302 and a Network 330.

The illustrated Computer 302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 302 can include an input device, such as a keypad, keyboard, or touch screen, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as, for example, a client, network component, a server, or a database or another persistency, or a combination of roles for performing the subject matter described in the present disclosure. The illustrated Computer 302 is communicably coupled with a Network 330. In some implementations, one or more components of the Computer 302 can be configured to operate within an environment, or a combination of environments, including cloud-computing, local, or global.

At a high level, the Computer 302 is an electronic computing device operable to receive, transmit, process, store, or manage data and information associated with the described subject matter. According to some implementations, the Computer 302 can also include or be communicably coupled with a server, such as an application server, e-mail server, web server, caching server, or streaming data server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory or conventional database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302. The Database 306 can hold and operate on at least any data type mentioned or any data type consistent with this disclosure.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

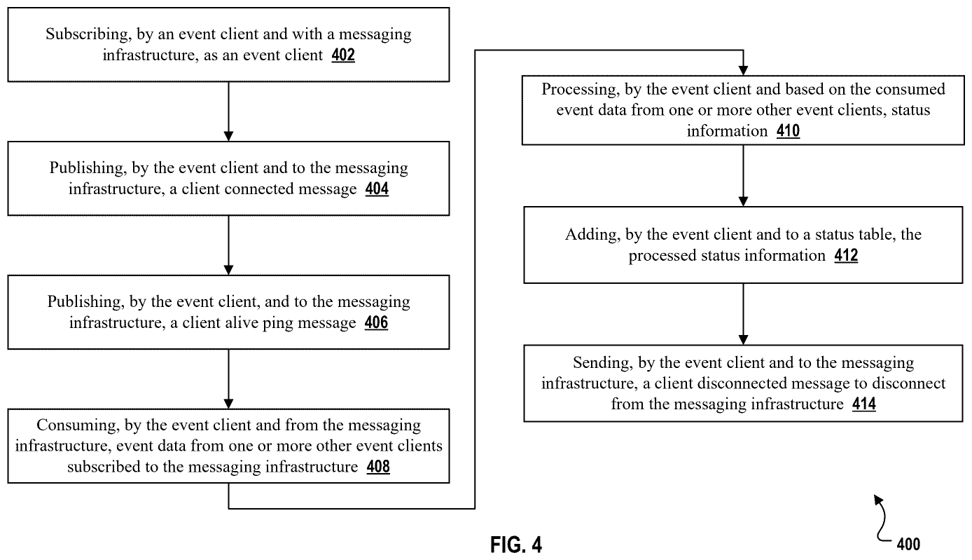

FIG. 4 is a flowchart illustrating an example of a computer-implemented method 400 for event-based introspection protocol for landscape and event exchange monitoring, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

In an event-based introspection protocol for landscape and event exchange monitoring:

At 402, an event client subscribes as an event client with a messaging infrastructure.

In some implementations, the event client can be an event producer, and event consumer, or both. In some implementations, subscribing, by an event client and with a messaging infrastructure, as an event client, includes subscribing for at least connected, alive, and disconnected message types. In some implementations, other message types are also possible for subscription. In some implementations, the messaging infrastructure generates a buffer for the event data associated with the event client. In some implementations, the buffer is defined by the event client using an application programming interface and the buffer can be defined for event data from an event producer or from an event consumer. In some implementations, the buffer is used to decouple applications by providing a data storage location for event producers and event consumers that produce and consume, respectively, at different rates. From 402, method 400 proceeds to 404.

At 404, the event client publishes a client connected message to the messaging infrastructure. From 404, method 400 proceeds to 406.

At 406, the event client publishes a client alive ping message to the messaging infrastructure. From 406, method 400 proceeds to 408.

At 408, the event client consumes event data from one or more other event clients subscribed to the messaging infrastructure from the messaging infrastructure. From 408, method 400 proceeds to 410.

At 410, the event client processes status information based on the consumed event data from one or more other event clients.

In some implementations, status of the one or more other event clients includes connected, alive, and disconnected. From 410, method 400 proceeds to 412.

At 412, the event client adds the processed status information to a status table.

In some implementations, an associated statistics table is generated for each entry in the status table. From 412, method 400 proceeds to 414.

At 414, the event client sends a client disconnected message to the messaging infrastructure to disconnect from the messaging infrastructure. After 414, method 400 can stop.

Described implementations of the subject matter can include one or more features, alone or in combination.

For example, in a first implementation, a computer-implemented method for event-based introspection protocol for landscape and event exchange monitoring, comprising: subscribing, by an event client and with a messaging infrastructure, as an event client; publishing, by the event client and to the messaging infrastructure, a client connected message; publishing, by the event client, and to the messaging infrastructure, a client alive ping message; consuming, by the event client and from the messaging infrastructure, event data from one or more other event clients subscribed to the messaging infrastructure; processing, by the event client and based on the consumed event data from one or more other event clients, status information; adding, by the event client and to a status table, the processed status information; and sending, by the event client and to the messaging infrastructure, a client disconnected message to disconnect from the messaging infrastructure.

The foregoing and other described implementations can each, optionally, include one or more of the following features:

A first feature, combinable with any of the following features, wherein the event client can be an event producer, and event consumer, or both.

A second feature, combinable with any of the previous or following features, wherein subscribing, by an event client and with a messaging infrastructure, as an event client, comprises subscribing for connected, alive, and disconnected message types.

A third feature, combinable with any of the previous or following features, comprising: generating, by the messaging infrastructure, a buffer for the event data associated with the event client, wherein the buffer is defined by the event client using an application programming interface, and wherein the buffer can be defined for event data from an event producer or from an event consumer.

A fourth feature, combinable with any of the previous or following features, wherein the buffer is used to decouple applications by providing a data storage location for event producers and event consumers that produce and consume, respectively, at different rates.

A fifth feature, combinable with any of the previous or following features, wherein status of the one or more other event clients includes connected, alive, and disconnected.

A sixth feature, combinable with any of the previous or following features, wherein an associated statistics table is generated for each entry in the status table.

For example, in a second implementation, a non-transitory, computer-readable medium storing one or more instructions executable by a computer system to perform one or more operations for event-based introspection protocol for landscape and event exchange monitoring, comprising: subscribing, by an event client and with a messaging infrastructure, as an event client; publishing, by the event client and to the messaging infrastructure, a client connected message; publishing, by the event client, and to the messaging infrastructure, a client alive ping message; consuming, by the event client and from the messaging infrastructure, event data from one or more other event clients subscribed to the messaging infrastructure; processing, by the event client and based on the consumed event data from one or more other event clients, status information; adding, by the event client and to a status table, the processed status information; and sending, by the event client and to the messaging infrastructure, a client disconnected message to disconnect from the messaging infrastructure.

The foregoing and other described implementations can each, optionally, include one or more of the following features:

A first feature, combinable with any of the following features, wherein the event client can be an event producer, and event consumer, or both.

A second feature, combinable with any of the previous or following features, wherein subscribing, by an event client and with a messaging infrastructure, as an event client, comprises subscribing for connected, alive, and disconnected message types.

A third feature, combinable with any of the previous or following features, comprising: generating, by the messaging infrastructure, a buffer for the event data associated with the event client, wherein the buffer is defined by the event client using an application programming interface, and wherein the buffer can be defined for event data from an event producer or from an event consumer.

A fourth feature, combinable with any of the previous or following features, wherein the buffer is used to decouple applications by providing a data storage location for event producers and event consumers that produce and consume, respectively, at different rates.

A fifth feature, combinable with any of the previous or following features, wherein status of the one or more other event clients includes connected, alive, and disconnected.

A sixth feature, combinable with any of the previous or following features, wherein an associated statistics table is generated for each entry in the status table.

For example, in a third implementation, a computer-implemented system for event-based introspection protocol for landscape and event exchange monitoring, comprising: one or more computers; and one or more computer memory devices interoperably coupled with the one or more computers and having tangible, non-transitory, machine-readable media storing one or more instructions that, when executed by the one or more computers, perform one or more operations, comprising: subscribing, by an event client and with a messaging infrastructure, as an event client; publishing, by the event client and to the messaging infrastructure, a client connected message; publishing, by the event client, and to the messaging infrastructure, a client alive ping message; consuming, by the event client and from the messaging infrastructure, event data from one or more other event clients subscribed to the messaging infrastructure; processing, by the event client and based on the consumed event data from one or more other event clients, status information; adding, by the event client and to a status table, the processed status information; and sending, by the event client and to the messaging infrastructure, a client disconnected message to disconnect from the messaging infrastructure.

The foregoing and other described implementations can each, optionally, include one or more of the following features:

A first feature, combinable with any of the following features, wherein the event client can be an event producer, and event consumer, or both.

A second feature, combinable with any of the previous or following features, wherein subscribing, by an event client and with a messaging infrastructure, as an event client, comprises subscribing for connected, alive, and disconnected message types.

A third feature, combinable with any of the previous or following features, comprising: generating, by the messaging infrastructure, a buffer for the event data associated with the event client, wherein the buffer is defined by the event client using an application programming interface, and wherein the buffer can be defined for event data from an event producer or from an event consumer.

A fourth feature, combinable with any of the previous or following features, wherein the buffer is used to decouple applications by providing a data storage location for event producers and event consumers that produce and consume, respectively, at different rates.

A fifth feature, combinable with any of the previous or following features, wherein status of the one or more other event clients includes connected, alive, and disconnected.

A sixth feature, combinable with any of the previous or following features, wherein an associated statistics table is generated for each entry in the status table.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU can receive instructions and data from and write to a memory. The essential elements of a computer are a CPU, for performing or executing instructions, and one or more memory devices for storing instructions and data. Generally, a computer can also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many particular implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some implementations, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations, steps, or actions are depicted in the Detailed Description, Drawings, and/or the Claims in a particular order, this should not be understood as requiring that such operations, steps, or actions be performed in the particular order shown or in sequential order, or that all illustrated operations, steps, or actions be performed (some operations, steps, or actions can be considered optional), to achieve desirable results. In certain circumstances, multitasking or parallel processing (or a combination of multitasking and parallel processing) can be advantageous and performed as deemed appropriate.

The separation or integration of various components and/or system modules in the previously described implementations should not be understood as requiring such separation or integration in all implementations. In some implementations, described components and system modules can be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation may be applicable to a computer-implemented method; a non-transitory, computer-readable medium storing computer-readable instructions to perform the computer-implemented method; and/or a computer system comprising a computer memory interoperably coupled with a hardware processor configured to perform the computer-implemented method or the instructions stored on the non-transitory, computer-readable medium.

What is claimed is:

1. A computer-implemented method for event-based introspection protocol for landscape and event exchange monitoring, comprising:
subscribing, by an event client and with a messaging infrastructure, as an event client;
publishing, by the event client and to the messaging infrastructure, a client connected message;
publishing, by the event client, and to the messaging infrastructure, a client alive ping message;
consuming, by the event client and from the messaging infrastructure, event data from one or more other event clients subscribed to the messaging infrastructure;
processing, by the event client and based on the consumed event data from one or more other event clients, status information;
adding, by the event client and to a status table, the processed status information; and
sending, by the event client and to the messaging infrastructure, a client disconnected message to disconnect from the messaging infrastructure.

2. The computer-implemented method of claim 1, wherein the event client can be an event producer, and event consumer, or both.

3. The computer-implemented method of claim 1, wherein subscribing, by an event client and with a messaging infrastructure, as an event client; comprises subscribing for connected, alive, and disconnected message types.

4. The computer-implemented method of claim 2, comprising:
generating, by the messaging infrastructure, a buffer for the event data associated with the event client, wherein the buffer is defined by the event client using an application programming interface, and wherein the buffer can be defined for event data from an event producer or from an event consumer.

5. The computer-implemented method of claim 4, wherein the buffer is used to decouple applications by providing a data storage location for event producers and event consumers that produce and consume, respectively, at different rates.

6. The computer-implemented method of claim 1, wherein status of the one or more other event clients includes connected, alive, and disconnected.

7. The computer-implemented method of claim 1, wherein an associated statistics table is generated for each entry in the status table.

8. A non-transitory, computer-readable medium storing one or more instructions executable by a computer system to perform one or more operations for event-based introspection protocol for landscape and event exchange monitoring, comprising:
subscribing, by an event client and with a messaging infrastructure, as an event client;
publishing, by the event client and to the messaging infrastructure, a client connected message;
publishing, by the event client, and to the messaging infrastructure, a client alive ping message;
consuming, by the event client and from the messaging infrastructure, event data from one or more other event clients subscribed to the messaging infrastructure;
processing, by the event client and based on the consumed event data from one or more other event clients, status information;
adding, by the event client and to a status table, the processed status information; and
sending, by the event client and to the messaging infrastructure, a client disconnected message to disconnect from the messaging infrastructure.

9. The non-transitory, computer-readable medium of claim 8, wherein the event client can be an event producer, and event consumer, or both.

10. The non-transitory, computer-readable medium of claim 8, wherein subscribing, by an event client and with a messaging infrastructure, as an event client, comprises subscribing for connected, alive, and disconnected message types.

11. The non-transitory, computer-readable medium of claim 9, comprising:
generating, by the messaging infrastructure, a buffer for the event data associated with the event client, wherein the buffer is defined by the event client using an application programming interface, and wherein the buffer can be defined for event data from an event producer or from an event consumer.

12. The non-transitory, computer-readable medium of claim 11,
wherein the buffer is used to decouple applications by providing a data storage location for event producers and event consumers that produce and consume, respectively, at different rates.

13. The non-transitory, computer-readable medium of claim 8, wherein status of the one or more other event clients includes connected, alive, and disconnected.

14. The non-transitory, computer-readable medium of claim 8, wherein an associated statistics table is generated for each entry in the status table.

15. A computer-implemented system for event-based introspection protocol for landscape and event exchange monitoring, comprising:
one or more computers; and
one or more computer memory devices interoperably coupled with the one or more computers and having tangible, non-transitory, machine-readable media storing one or more instructions that, when executed by the one or more computers, perform one or more operations, comprising:
subscribing, by an event client and with a messaging infrastructure, as an event client;
publishing, by the event client and to the messaging infrastructure, a client connected message;
publishing, by the event client, and to the messaging infrastructure, a client alive ping message;
consuming, by the event client and from the messaging infrastructure, event data from one or more other event clients subscribed to the messaging infrastructure;
processing, by the event client and based on the consumed event data from one or more other event clients, status information;
adding, by the event client and to a status table, the processed status information; and
sending, by the event client and to the messaging infrastructure, a client disconnected message to disconnect from the messaging infrastructure.

16. The computer-implemented system of claim 15, wherein the event client can be an event producer, and event consumer, or both.

17. The computer-implemented system of claim 15, wherein subscribing, by an event client and with a messaging infrastructure, as an event client, comprises subscribing for connected, alive, and disconnected message types.

18. The computer-implemented system of claim 16, comprising:
generating, by the messaging infrastructure, a buffer for the event data associated with the event client, wherein the buffer is defined by the event client using an application programming interface, and wherein the buffer can be defined for event data from an event producer or from an event consumer.

19. The computer-implemented system of claim 18, wherein the buffer is used to decouple applications by providing a data storage location for event producers and event consumers that produce and consume, respectively, at different rates.

20. The computer-implemented system of claim 15, wherein status of the one or more other event clients includes connected, alive, and disconnected.
